(19) United States
(12) Patent Application Publication
(10) Pub. No.: US 2019/0322367 A1
(43) Pub. Date: Oct. 24, 2019

(54) METHOD OF CONTROLLING AN UNMANNED AERIAL ROAD SIDE UNIT DRONE

(71) Applicant: Lear Corporation, Southfield, MI (US)

(72) Inventor: Younes El Hajjaji El Idrissi, Sale (MA)

(73) Assignee: Lear Corporation, Southfield, MI (US)

(21) Appl. No.: 15/959,547

(22) Filed: Apr. 23, 2018

(51) Int. Cl. B64C 39/02; G08G 5/00; G08G 1/01; H04W 4/44; H04W 4/46; G08G 1/00; G07C 5/00

(52) U.S. Cl. CPC B64C 39/024; G08G 5/003; G08G 1/012; H04W 4/44; B64C 2201/145; G08G 1/207; G07C 5/008; B64C 2201/122; H04W 4/46

(57) ABSTRACT

A method of controlling an unmanned aerial road side unit (ARSU) drone. The ARSU drone may be dispatched to an uncovered zone that is outside of the coverage zones of a network of land-based road side units. Wireless communication may be established between the ARSU drone and the vehicle in the uncovered zone.

### TECHNICAL FIELD

This disclosure relates to a method of controlling an unmanned aerial road side unit drone, such as in conjunction with vehicle to infrastructure technologies.

### BACKGROUND

A system and method for controlling an unmanned aerial vehicle over a cellular network is disclosed in United States Patent Publication No. 2017/0023939.

### SUMMARY

In at least one embodiment, a method of controlling an unmanned aerial road side unit (ARSU) drone is provided. The method may include providing a network of land-based road side units. Each land-based road side unit may have a coverage zone in which the land-based road side unit may be configured to wirelessly communicate with a vehicle in the coverage zone. The ARSU drone may be dispatched to an uncovered zone that is outside of the coverage zones of the network of land-based road side units. The network of land-based road side units may not communicate with a vehicle in an uncovered zone. Wireless communication may be established between the ARSU drone and the vehicle in the uncovered zone.

### BRIEF DESCRIPTION OF THE DRAWINGS

FIG. 1 is a schematic representation of a portion of a transportation system that is partially covered by a network of land-based road side units and unmanned aerial road side unit drones in various uncovered zones that are not covered by the network of land-based road side units.

FIG. 2 is a schematic representation of communication associated with the transportation system, including communication between a control center and vehicles via the network of land-based road side units and an unmanned aerial road side unit drone.

FIG. 3 is a flowchart of a method of controlling an unmanned aerial road side unit drone.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

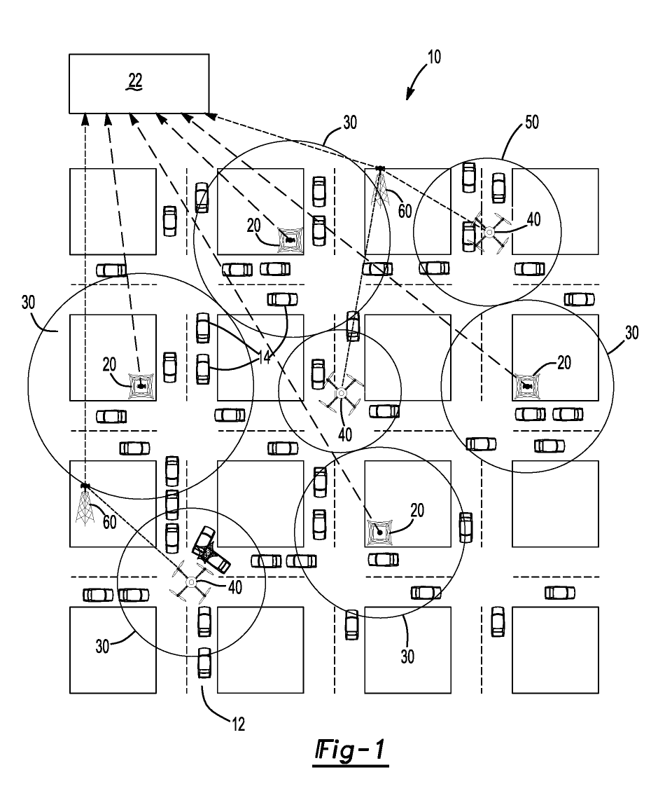

Referring to FIG. 1, a schematic representation of a portion of a transportation system 10 is shown. The transportation system 10 may include road infrastructure 12 upon which vehicles 14 may travel. For example, road infrastructure 12 may include streets, highways, and the like.

The transportation system 10 may include “intelligent infrastructure” that may monitor or detect vehicles 14, communicate with vehicles 14, or combinations thereof. For instance, at least a portion of the transportation system 10 may be an intelligent transportation system that may include vehicle-to-infrastructure (V2I) technologies. V2I technologies may capture data, such as vehicle-based traffic data or vehicle-generated traffic data, and wirelessly provide information, such as advisories, warnings, or vehicle routing information to vehicles that may inform the vehicle or a vehicle occupant of safety, mobility, or environment-related conditions. For instance, V2I technologies or networks may provide information regarding road conditions, real-time traffic conditions, congestion warnings, and Signal Phase and Timing (SPaT) to enable proactive transportation management responses, such as changing the vehicle route to help avoid or reduce traffic congestion, and the like.

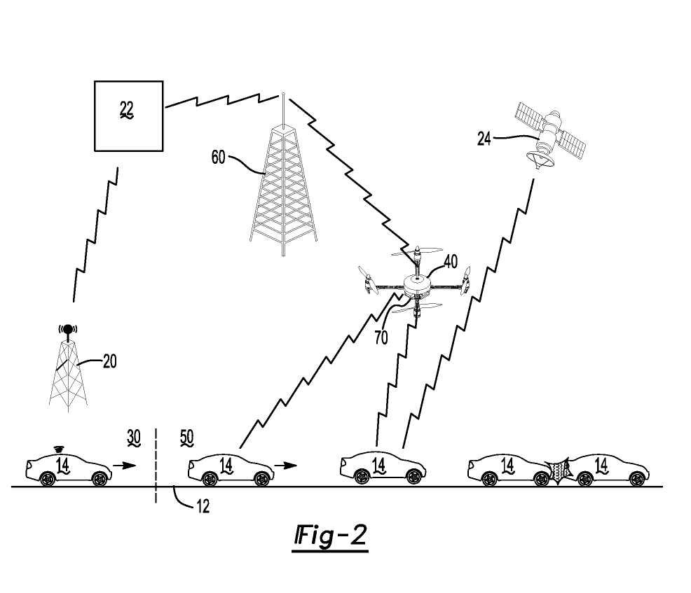

In at least one configuration, the transportation system 10 may include a network of road side units 20 or RSUs. A road side unit 20 may configured to communicate with a remotely located transportation management center or control center 22. Wireless communication between a road side unit 20 and the control center 22 is represented by the arrowed dashed lines in FIG. 1 and by the lightning-bolt line between the road side unit 20 and the control center 22 in FIG. 2.

A road side unit 20 may be a stationary, land-based device that may be installed on or in buildings, poles, or electrical cabinets that may be located near the road infrastructure 12. A road side unit 20 may include a communication system and a controller.

The communication system may include one or more antennas, transponders, transceivers, or the like that may detect vehicles or communicate with vehicles that are located in the coverage zone 30 of the road side unit 20. In FIG. 1, the coverage zone 30 for each road side unit 20 is represented by a circle that is centered on the road side unit 20; however, it is contemplated that the coverage zone 30 may not be circular and may be affected by buildings, terrain, or other attributes of environment surrounding the road side unit 20. In FIG. 2, the border of the coverage zone 30 is represented by the vertical dashed line. It is contemplated that road side units 20 may communicate with the control center 22 via a wireless connection, a wired connection, or combinations thereof.

The controller may control operation of the communication system and may facilitate communication with the network of road side units 20 and its control center 22. In at least one configuration, the controller may be a dedicated networkable microprocessor-based computer.

A vehicle 14 may be a land vehicle such as a car, truck, bus, or the like. For simplicity, the vehicles 14 in FIG. 1 are depicted with a common symbol. Moreover, not all of the vehicles 14 are labeled in FIG. 1 for clarity.

One or more of the vehicles in the coverage zone 30 may be configured as a connected vehicle. A connected vehicle may wirelessly communicate with other connected vehicles (vehicle-to-vehicle or “V2V”), with infrastructure (V2I), with mobile devices, or combinations thereof.

A connected vehicle may or may not be an automated vehicle. An automated vehicle may be a vehicle in which at least some aspect of a safety-critical control function (e.g., steering, throttle, or braking) may occur without direct driver input. An automated vehicle may use and rely on onboard sensors to collect information about the vehicle's surroundings and may use this information to operate the vehicle. Widespread adoption of highly automated vehicles, such as vehicles that may handle most or all driving functions without a human driver, may not occur for many years. However, vehicles assisted by V2V and V2I applications may be available in a shorter timeframe.

The vehicle 14 may be a connected vehicle that may be equipped with an On Board Unit (OBU) which may have one or more antennas, transceivers, transponders, or combinations thereof and an associated controller that may control operation of the OBU and associated communication activities. In addition, the vehicle 14 and its OBU may directly or indirectly receive data from a global positioning system (GPS) that may be indicative of the location of the vehicle 14. The global positioning system 24 is represented by a satellite in FIG. 2 with GPS communication being represented by the lightning bolt symbol extending from the satellite.

A communication link may be established between the road side unit 20 and an On Board Unit (OBU) of a vehicle 14 that is located within the coverage zone 30 of the road side unit 20. Such a communication link is represented by the wave signals emanating from the vehicle 14 and the road side unit 20 in FIG. 2. The communication link may allow information, including but not limited to time or timestamp data, vehicle location data, vehicle speed or velocity data, and the like to be transmitted between the vehicle 14 to the road side unit 20. This information or data may then be used to monitor and evaluate traffic conditions. For instance, information or data acquired by the road side unit 20 may be used to monitor traffic, estimate the location where traffic congestion has originated (“Start of Congestion”), estimate the magnitude or amount of traffic congestion in or near the coverage zone 30, or combinations thereof.

A road side unit 20 may communicate with a connected vehicle 14 in its coverage zone using various types of communication networks or signals, such as Dedicated Short-Range Communications (DSRC), cellular, and Wi-Fi.

DSRC may operate in a predetermined electromagnetic spectrum. For instance, in the United States, DSRC may operate over 75 megahertz (MHz) of spectrum in the 5.9 gigahertz (GHz) band allocated for transportation safety purposes by the Federal Communications Commission (FCC). DSRC may provide low-latency, short-to-medium-range wireless communication that may permit very fast and reliable data transmissions.

Cellular technology may also be employed for vehicle-to-infrastructure (V2I) communication. Current cellular technology using fourth-generation (4G) and third-generation (3G) mobile networks, such as those provided by private carriers such as Verizon and AT&T, may not consistently provide the low latency desired for some safety-related applications, but may adequately transfer or communicate data to and/or from a control center 22 for other purposes, including but not limited to traffic and road condition data. Latency shortcomings may be addressed by future cellular networks, such as fifth-generation (5G) mobile networks.

Current Wi-Fi communications are typically short range and may not as reliable as DSRC for communications with moving vehicles. However, Wi-Fi can carry large data transfers in areas where vehicles may be stationary for extended periods of time. Reliability issues associated with communication with moving vehicles may be alleviated by future technological developments in this field.

Referring to FIG. 1, the network of land-based road side units is depicted as having coverage zones that may not completely cover the road infrastructure 12. For example, a coverage zone 30 may or may not overlap with another coverage zone 30 or be contiguous with another coverage zone 30. In the areas outside of the coverage zones 30, such as where one coverage zone 30 does not border or overlap another coverage zone 30, an uncovered zone may exist. In FIG. 1, uncovered zones may be represented by areas outside of the coverage zones 30.

Uncovered zones may be identified on a coverage map, similar to coverage maps that are associated with cellular networks and designate where a cellular network coverage is not available. For instance, coverage maps may be plotted by directly assessing or measuring the signal strength around a road side unit 20 such that an area may be deemed uncovered when the signal strength is below a predetermined threshold. Alternatively, a coverage map may be generated based on distance from the road side unit 20. For example, an area may be deemed uncovered when it is more than a threshold distance from any road side unit 20. The threshold distance may be based on the design specifications and performance attributes of the road side unit 20. As one nonlimiting example, the threshold distance may be 750 meters.

A road side unit 20 may not communicate with vehicles 14 outside of its coverage zone 30. Conversely, a vehicle 14 in an uncovered zone may not communicate with a road side unit 20. Accordingly, uncovered zones may be blind spots in which the network of road side units 20 may not communicate with a vehicle 14 to directly obtain data from the vehicle 14 that may be used to assess traffic congestion or accidents that may affect traffic flow. As a result, the control center 22 may not have sufficient data, timely data, or sufficiently accurate data to be able to calculate or model traffic flow conditions or traffic densities in an uncovered zone with sufficient accuracy. Moreover, the transportation system may be unable to communicate with vehicles outside of the coverage zones 30 to help route vehicles away from high congestion areas or accidents, which may increase vehicle travel times, air pollution, and fuel consumption.

Installing additional road side units 20 to reduce the number of uncovered zones or the size of the uncovered zones may be expensive and time-consuming and may increase transportation system maintenance costs. Moreover, there may be insufficient return on investment or insufficient benefits in relieving traffic congestion when road side units 20 are installed in locations that have low traffic density or that rarely, if ever, experience traffic congestion or accidents.

One or more aerial road side unit (ARSU) drones 40, which may be called a drone below for brevity, may be dispatched to uncovered zones instead of installing additional land-based road side units 20 to reduce or eliminate coverage gaps. An aerial road side unit drone 40 may be a mobile flying road side unit that may have the functionality of a road side unit 20 as discussed above, but may be flown to an uncovered zone to obtain or communicate road or traffic-related data.

The aerial road side unit drone 40 may be an unmanned vehicle that may be controlled in any suitable manner, such as via a cellular network that may facilitate communication between the control center 22 and the aerial road side unit drone 40. In FIGS. 1 and 2, cellular network antennas 60 are shown to represent a cellular network. Cellular network communication in FIG. 1 is represented by the dotted lines between the cellular network antennas 60 and the control center 22 and between the cellular network antennas and a drone 40. Cellular network communication in FIG. 2 is represented by the lightning bolt symbols between the cellular network antennas 60 and the control center 22 and between the cellular network antennas and a drone 40.

The aerial road side unit drone 40 may be powered in any suitable manner, such as with batteries, solar power, or combinations thereof, which may help facilitate extended deployment times. In addition, the drone 40 may provide and Internet connection to one or more connected vehicles in the uncovered zone with which the drone 40 has established communication.

Each aerial road side unit drone 40 may have an associated drone coverage zone 50. The aerial road side unit drone 40 may detect vehicles 14 or may communicate with vehicles 14 that are located in its drone coverage zone 50. In FIG. 1, the drone coverage zone 50 for each aerial road side unit drone 40 is represented by a circle that is centered on the aerial road side unit drone 40; however, it is contemplated that the drone coverage zone 50 may not be circular and may be affected by buildings, terrain, interference, drone orientation, or attributes of the environment surrounding the aerial road side unit drone 40. In FIG. 2, the border of the drone coverage zone 50 is represented by the region to the right of the vertical dashed line; however, it is contemplated that the drone coverage zone 50 may not be contiguous with a coverage zone 30 of a road side unit 20 in some circumstances. It is contemplated that road side units 20 may communicate with the control center 22 via a wireless connection, a wired connection, or combinations thereof.

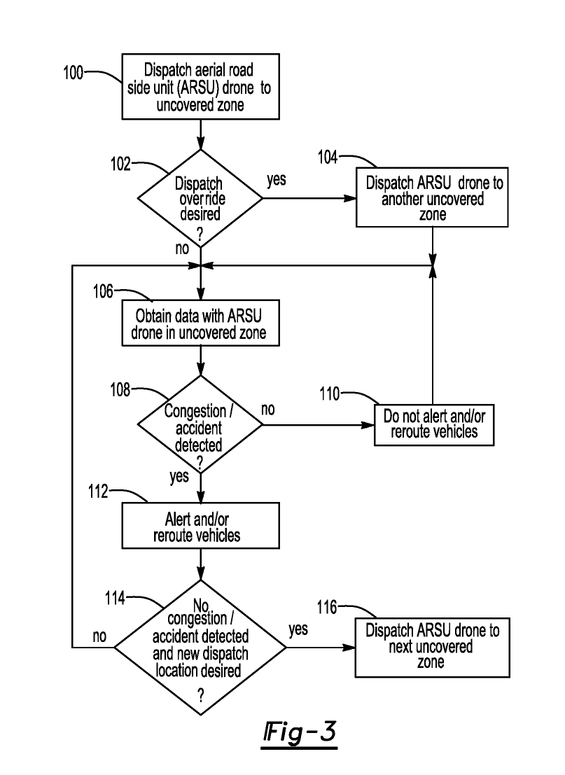

Referring to FIG. 3, a method of controlling an unmanned aerial road side unit drone 40 is shown. The method may utilize a coverage map that may designate or delineate coverage zones 30 and uncovered zones as previously discussed. It is also contemplated that the coverage map may be manually or automatically updated by the control center 22 such that the coverage zone 30 of a road side unit 20 is redesignated as being an uncovered zone when the road side unit 20 is unable to communicate with the control center 22, when communication between the road side unit 20 and the control center 22 is lost for a predetermined amount of time, or when the road side unit 20 is unable to communicate with vehicles 14 in its coverage zone 50. Such a redesignation may be indicative of a power failure, hardware failure of the road side unit 20, or other connectivity issues.

At block 100, a drone 40 may be dispatched to an uncovered zone. The drone 40 may be dispatched automatically or manually. For example, a drone may be dispatched automatically by the control center 22 based on a predetermined schedule. An example of a predetermined schedule for dispatching a drone 40 is shown in the table below.

TABLE 1
ARSU Drone Dispatch Schedule

| Coordinates | Start Time | Duration (min) |
|---|---|---|
| 41°55.443′N, 74°24.808′W | 7:00 | 90 |
| 41°55.416′N, 74°24.183′W | 10:05 | 30 |
| 41°55.515′N, 74°24.519′W | 10:45 | 15 |
| 41°52.148′N, 74°23.651′W | 11:05 | 30 |
| 41°55.443′N, 74°24.808′W | 12:00 | 60 |
| 41°55.515′N, 74°24.519′W | 16:00 | 120 |
| 41°52.148′N, 74°23.651′W | 20:30 | 180 |

In Table 1, the coordinates may be target latitude and longitude locations to which the drone 40 may be deployed. The drone 40 may use GPS data to determine its current location. A flight plan for the drone 40 may be based on the GPS data and the coordinates. Moreover, a flight plan for the drone 40 may also account for obstructions (radio antennas, buildings, etc.) so that the drone 40 may avoid flying into such obstacles or obstructions. The coordinates may represent a target location at which the drone 40 may hover or may remain sufficiently close to so that the drone coverage zone 50 may cover a sufficient or predetermined amount of the uncovered zone. For instance, the target location may be a location at which the drone 40 may provide a drone coverage zone 50 that may border or overlap at least one adjacent coverage zone 30.

Although not shown in the table, the dispatch schedule may include a target altitude for the drone 40 at the coordinates and optionally along its flight path. In at least one configuration, the target altitude may be designated as a range that may include a minimum altitude and a maximum altitude. The minimum altitude and maximum altitude may be established based on the performance characteristics of the drone 40, such as its transmission or receiving range, power level or battery strength, weather conditions, known sources of interference, and the like. As one example, a drone 40 may be deployed to an initial target location and the signal strength may be monitored at ground level by varying the altitude or distance of the drone 40 from the target location to determine a maximum and minimum altitude range, to fine-tune the target location coordinates, or both.

The start time may be the time at which the drone 40 is scheduled to begin providing coverage or vehicle monitoring or communication in a previously uncovered zone. The start time may or may not be the same as the time at which the drone 40 may arrive at the corresponding coordinates.

The duration may be an amount of time that the drone 40 is scheduled to remain at or sufficiently close to the target coordinates. The duration may be measured starting at the start time. It is noted that the duration value may be less than the amount of time between the current start time and the next start time in the table. This may provide sufficient time for the drone 40 to travel to its next location or may provide time for recharging, maintenance, or servicing of the drone 40.

The dispatching schedule may be based on historical traffic history data. For example, a drone 40 may be dispatched to uncovered zones at times at which traffic congestion is expected to increase or the likelihood of an accident is expected to increase.

A drone 40 may be dispatched manually based on individual dispatching commands, such as may be provided by the control center 22. Such commands may be communicated from the control center 22 to the drone 40 via a communication network, such as a cellular communication network.

At block 102, the method may determine whether redeployment of the drone 40 is desired. Redeployment of a drone 40 may override the current dispatching schedule or a previous dispatching command. For example, a redeployment command or override command may be communicated from the control center 22 to the drone 40 to dispatch the drone 40 to another location and deviate from the drone dispatch schedule. The control center 22 may issue a redeployment based on actual, predicted, or perceived traffic concerns. For instance, the control center 22 may receive information from a road side unit 20 or another drone 40 that may be indicative of traffic congestion in an uncovered zone. As one example, a dispatcher at the control center 22 may receive video data that may show traffic congestion in a coverage zone 30 or may receive data from a road side unit 20 that may indicate that traffic congestion in a coverage zone 30 may extend to an uncovered zone or may be originating in an uncovered zone that may border the coverage zone 30. In at least one embodiment, the dispatcher may be a person that may receive and evaluate information from the traffic infrastructure; however, it is contemplated that the dispatcher or functions of the dispatcher may be partially automated or wholly automated. As another example, it is contemplated that a redeployment command may be desired when no traffic congestion or lower-than-expected traffic congestion is detected in an uncovered zone in which the drone 40 is currently located. If overriding the current dispatching schedule or dispatching command is desired, then the method may continue at block 104. If overriding the current dispatching schedule or dispatching command is not desired, then the method may continue at block 106.

At block 104, the drone 40 may be dispatched to another uncovered zone or a new uncovered zone. In at least one configuration, the dispatcher may issue a redeployment command to dispatch a drone 40 to another uncovered zone or a new uncovered zone to obtain additional information. The redeployment command may dispatch the drone 40 to a predetermined location in the uncovered zone. Moreover, it is contemplated that the control center 22 may remotely control the flight path of the drone 40 to follow or track the traffic congestion to its source when the source of the congestion is not readily detectable at the predetermined location. In this manner, the control center 22 may alter the flight path of the drone 40 to track congestion to its source.

At block 106, the drone 40 may obtain data in the uncovered zone. The drone 40 may obtain information in various ways. As one example, the drone 40 may be equipped with a camera 70 and may provide video information showing the traffic conditions below the drone 40. As such, the drone 40 may provide pictures or a video feed to the control center 22 to provide traffic information in the uncovered zone. Such video information may be provided without establishing wireless communication with a vehicle 14 in the uncovered zone. It is also contemplated that video information may be captured by a camera on the vehicle 14 and may be relayed by the drone 40 to the control center 22. As another example, the drone 40 may establish wireless communication with one or more vehicles 14 in the uncovered zone below the drone 40 and may receive non-video information indicative of traffic conditions, such as vehicle speed, location, and direction of travel. As such, the drone 40 may obtain traffic information wirelessly from one or more vehicles 14, making the transmission of video information optional. The drone 40 may wirelessly communicate with a vehicle 14 using the same communication techniques that may be associated with a land-based road side unit 20. In addition, the drone 40 may communicate with the control center 22 in any suitable manner, such as with the cellular network.

At block 108, the traffic conditions in the current uncovered zone may be evaluated based on the data provided by the drone 40. Evaluation of traffic conditions may include determining whether a vehicle accident is detected or whether excessive or unexpected traffic congestion is present (e.g., vehicle volumes and speeds that exceed the average volumes and speeds or expected volumes and speeds at that location at that time of day). A determination as to whether traffic congestion may be present in the current uncovered zone based on data that may be indicative of speed, velocity, and location of one or more vehicles 14 in the uncovered zone. In at least one configuration, the drone 40 may receive vehicle speed or velocity data and vehicle location data from a vehicle 14. For instance, the vehicle location and vehicle speed or velocity may be based on GPS data and may be calculated or may be provided by the onboard unit on the vehicle 14. This data may be communicated to the drone 40, which in turn may relay the data to the control center 22. The control center 22 may then assess the vehicle speed or velocity and location data from one or more vehicles 14 to determine whether excessive or unexpected traffic congestion is present in the uncovered zone in which the drone 40 is deployed. An accident may result in increased traffic congestion, which may be detectable by low vehicle speeds, vehicles that are stopped unexpectedly (e.g., one or more vehicles 14 that are stopped but have a green light or the right of way), or one or more vehicles that are travelling (e.g., not parked) and are stopped for a predetermined period of time (e.g., more than 3 minutes). If an accident or unexpected traffic congestion is not detected, then the method may continue at block 110. If an accident or unexpected traffic congestion is detected, then the method may continue at block 112.

At block 110, vehicles may not be alerted or rerouted as unexpected traffic congestion has not been detected.

At block 112, one or more vehicles 14 may be alerted to the traffic congestion, rerouted to avoid the traffic congestion, or both. A vehicle 14 may be alerted when it is in the uncovered zone that is occupied by the drone 40 and is moving in a direction toward the traffic congestion. An alert may be relayed from the control center 22 to the drone 40 and then to vehicles 14 that are in the drone coverage zone 50. An alert may be provided to a vehicle occupant in any suitable manner. For example, the alert may be a visual alert, audible alert, haptic alert or combinations thereof. As an example, a traffic warning message may be displayed on a display screen in the vehicle 14 or may be provided audibly or verbally, such as via the vehicle audio system. In addition, the drone 40 may provide new route information or to a vehicle navigation system or may provide updated traffic information that may allow the vehicle navigation system to plot a new route that may help avoid the traffic congestion. It is also contemplated that a land-based road side unit 20 in at least one coverage zone 30 that borders the uncovered zone in which the drone 40 is present may send a warning signal to one or more vehicles 14 in its coverage zone 30 when traffic congestion is detected in the bordering uncovered zone. Moreover, it is contemplated that the warning signal may only be sent to vehicles 14 in the coverage zone 30 that are heading toward the uncovered zone or toward the location in which congestion has been detected.

At block 114, an assessment is made as to whether the drone 40 should be redeployed from its current location to a new location. The assessment may be based on the dispatching schedule and whether congestion is detected in the uncovered zone in which the drone 40 is currently occupied. For example, if the drone 40 is not scheduled to leave its current location (e.g., the duration time has not elapsed), then the method iteration may end or the method make return to block 106. If the drone 40 is scheduled to leave its current location and unexpected congestion or an accident is still detected in the uncovered zone in which the drone 40 is currently occupied, then the method may override the dispatch schedule and keep the drone 40 at its current location until the congestion has sufficiently diminished or the accident has been cleared. If the drone 40 is scheduled to leave its current location and unexpected congestion or an accident is not detected in its current location, then the method may continue at block 116.

At block 116, the drone 40 may be dispatched to the next uncovered zone. The next uncovered zone may be the next location in the drone dispatch schedule. Block 116 may represent the end of an iteration of the method. As such, block 116 may be analogous to block 100.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method of controlling an unmanned aerial road side unit (ARSU) drone comprising:
providing a network of land-based road side units, wherein each land-based road side unit has a coverage zone in which the land-based road side unit is configured to wirelessly communicate with a vehicle in the coverage zone;
dispatching the ARSU drone to an uncovered zone that is outside of the coverage zones of the network of land-based road side units, wherein the network of land-based road side units does not communicate with a vehicle in the uncovered zone; and
establishing wireless communication between the ARSU drone and the vehicle in the uncovered zone.

2. The method of claim 1 wherein the uncovered zone borders at least one coverage zone.

3. The method of claim 2 wherein the ARSU drone is dispatched to the uncovered zone for a predetermined period of time.

4. The method of claim 3 wherein the ARSU drone is dispatched from the uncovered zone to a second uncovered zone after the predetermined period of time has elapsed.

5. The method of claim 2 wherein the network of land-based road side units communicates with a control center.

6. The method of claim 5 wherein the coverage zone of the land-based road side unit is redesignated as being an uncovered zone by the control center when the control center is unable to communicate with land-based road side unit or the land-based road side unit is unable to communicate with vehicles in its coverage zone.

7. The method of claim 5 wherein the ARSU is scheduled to remain in the uncovered zone for a predetermined period of time and is routed to a second uncovered zone that borders at least one coverage zone before the predetermined period of time has elapsed based on a redeployment command from the control center.

8. The method of claim 7 wherein the redeployment command is based on a signal from the land-based road side unit that is located in the coverage zone that borders the uncovered zone in which the ARSU is located.

9. The method of claim 7 wherein the redeployment command is based on a signal from a sensor that is located in the uncovered zone that communicates with the control center that does not communicate with the network of land-based road side units.

10. The method of claim 5 wherein the ARSU drone is scheduled to remain in the uncovered zone for a predetermined period of time and is not routed to a second uncovered zone that borders at least one coverage zone when the predetermined period of time has elapsed based on a command from the control center.

11. The method of claim 5 wherein the ARSU drone wirelessly receives data transmitted from the vehicle in the uncovered zone that is indicative of speed and location of the vehicle and wirelessly sends the data to the control center.

12. The method of claim 11 wherein the control center determines whether traffic congestion is present in the uncovered zone based on the data that is indicative of speed and location of the vehicle in the uncovered zone.

13. The method of claim 12 wherein the speed and location of the vehicle are based on data from a global positioning system and are wirelessly communicated from the vehicle to the ARSU drone.

14. The method of claim 12 wherein the ARSU drone sends a warning message to vehicles in the uncovered zone when traffic congestion is detected in the uncovered zone.

15. The method of claim 14 wherein the land-based road side unit in at least one coverage zone that borders the uncovered zone sends a signal to vehicles in the coverage zone when traffic congestion is detected in the uncovered zone that borders the coverage zone.

16. The method of claim 5 wherein the ARSU drone has a camera, the ARSU drone sends data acquired by the camera to the control center, and the control center determines whether congestion is present in the uncovered zone based on the data acquired by the camera.

17. The method of claim 16 wherein the land-based road side unit in at least one coverage zone that borders the uncovered zone sends a warning signal to the vehicle in the coverage zone when traffic congestion is detected in the uncovered zone that borders the coverage zone.

18. The method of claim 16 wherein the land-based road side unit in at least one coverage zone that borders the uncovered zone sends a warning signal to the vehicle in the coverage zone when traffic congestion is detected in the uncovered zone and the vehicle in the coverage zone is heading toward the uncovered zone.

19. The method of claim 5 wherein the control center wirelessly communicates with the ARSU drone via a cellular network.

20. The method of claim 19 wherein the ARSU drone provides an internet connection to the vehicle in the uncovered zone.
